(19) United States
(12) Patent Application Publication
(10) Pub. No.: US 2017/0120208 A1
(43) Pub. Date: May 4, 2017

(54) BLENDER CONTROL PANEL

(71) Applicant: Vita-Mix Management Corporation, Olmsted Township, OH (US)

(72) Inventors: David J. Kolar, Stow, OH (US); Fred Mehlman, Brunswick, OH (US); Robin Shorr, Olmsted Township, OH (US)

(21) Appl. No.: 15/259,188

(22) Filed: Sep. 8, 2016

Related U.S. Application Data
(60) Provisional application No. 62/215,357, filed on Sep. 8, 2015.
(60) Provisional application No. 62/241,464, filed on Oct. 14, 2015.

(51) Int. Cl. B01F 15/00; G05B 19/416; G05B 19/409; B01F 7/18; G05B 19/042

(52) U.S. Cl. CPC B01F 15/00474; B01F 15/00253; B01F 7/18; G05B 19/0423; G05B 19/409; G05B 19/416; B01F 2015/00597; G05B 2219/34282

(57) ABSTRACT

A control panel for a blender assembly is shown and described. The control panel may include a body integrated with controls. The body may also be integrated with circuitry, such as a printed circuit board. The controls may interact with the printed circuit board to control operation of the blender assembly.

### CROSS-REFERENCE TO RELATED APPLICATIONS

This application claims priority to U.S. Provisional Patent Application No. 62/215,357 entitled “BLENDER CONTROL PANEL,” filed on Sep. 8, 2015, and to U.S. Provisional Patent Application No. 62/241,464 entitled “BLENDER CONTROL PANEL,” filed on Oct. 14, 2015, each of which is incorporated herein by reference in its entirety.

### FIELD OF THE INVENTION

The present invention is generally related to a blender and, more particularly, to a control panel for a blending device.

### BACKGROUND

Blenders traditionally include a blender base that includes controls. The controls allow a user to adjust blender settings, turn on/off a blender, or pulse a blender. The controls are typically directly connected with a motor. In traditional blenders, the controls are formed as part of the blender base.

### SUMMARY

The present teachings relate to a blender assembly or more specifically to a control panel for blending device. A blending device may include a blender base. The blender base may include a housing that houses a motor. The motor may drive a blade assembly operatively engaged thereto. The control panel may operatively couple to the housing. The control panel may comprise controls for operating the motor.

In an aspect, the control panel may comprise mountings for the controls. The mountings may include mountings for switches, knobs, display screens, printed circuit boards, and/or other components. The control panel may be operatively engaged with the controls and the printed circuit board. A user may interact with the controls. The controls may interact with the printed circuit board, and the printed circuit board may interact with a motor. For instance, the printed circuit board may generate instruction signals to control a speed, power, or other parameter of the motor.

Exemplary embodiments of the control panel are shown in the attached drawings. The control panel, however, is not limited to that shown and described herein. It may be of any appropriate configuration.

### BRIEF DESCRIPTION OF THE DRAWINGS

The present teachings may be better understood by reference to the following detailed description taken in connection with the following illustrations, wherein:

FIG. 1A depicts a back perspective view of a control panel assembly, in accordance with various described embodiments;

FIG. 2 depicts a back perspective view of the control panel assembly of FIG. 1A, operatively disengaged with a printed circuit board, in accordance with various described embodiments;

FIG. 3A depicts a front perspective view of the control panel assembly of FIG. 1A with a paddle, in accordance with various described embodiments;

FIG. 3B depicts another front perspective view of the control panel assembly of FIG. 1A with an attached paddle and a detached paddle, in accordance with various described embodiments;

FIG. 3C depicts another front perspective view of the control panel assembly of FIG. 1A with two attached paddles, in accordance with various described embodiments;

FIG. 4 depicts a front view of a blender base that may be operatively coupled to a control panel assembly, in accordance with various described embodiments;

FIG. 5 depicts a front view of the blender base of claim 4 coupled to a control panel assembly, in accordance with various described embodiments;

FIG. 6 depicts a partial, cross-sectional view of a control panel assembly, in accordance with various described embodiments;

FIGS. 7-9 depict partial, cross-sectional views of the control panel assembly of FIG. 1A, in accordance with various described embodiments;

FIG. 10 depicts a front view of a blender system including a control panel assembly, in accordance with various described embodiments;

FIG. 11 depicts a perspective side view of a control panel of the blender system of FIG. 10, in accordance with various described embodiments;

FIG. 12 depicts a perspective back view of the control panel of FIG. 11, in accordance with various described embodiments;

FIG. 13-14 depict a PCB of the blender system of FIG. 10, in accordance with various described embodiments;

FIG. 15 depicts a partial, cross-sectional view of another control panel of the blender system of FIG. 10, in accordance with various described embodiments;

FIG. 16 depicts a perspective side view of the control panel of FIG. 15 with an exploded view of a paddle, in accordance with various described embodiments;

FIG. 17 depicts a perspective side view of the control panel of FIG. 15 with an actuator in a first position, in accordance with various described embodiments; and

FIG. 18 depicts a perspective side view of the control panel of FIG. 15 with an actuator in a second position, in accordance with various described embodiments.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

It is noted that the various embodiments described herein may include other components and/or functionality. It is further noted that while various embodiments refer to a blender or a blender system, various other systems may be utilized in view of embodiments described herein. For example, embodiments may be utilized in food processor systems, mixing systems, hand-held blender systems, various other food preparation systems, and the like. As such, references to a blender, blender system, and the like, are understood to include food processor systems, and other mixing systems. Such systems generally include a blender base that may include a motor, a controller, a display, a memory and a processor. Further, such systems may include a blending container and a blade assembly. The blade assembly, the blending container, and the blender base may removably or irremovably attach. The blending container may be powered in any appropriate manner, such as disclosed in U.S. patent application Ser. No. 14/213,557, entitled Powered Blending Container, which is hereby incorporated by reference.

While blending of “ingredients,” “contents” or “foodstuffs” is described by various embodiments, it is noted that non-food stuff may be mixed or blended, such as paints, epoxies, construction material (e.g., mortar, cement, etc.), and the like. Further, blender systems may include any household blender and/or any type of commercial blender system, including those with covers that may encapsulate or partially encapsulate the blender. Further, commercial blender systems may include an overall blender system, such as a modular blender system that may include the blender along with other components, such as a cleaner, foodstuff storage device (including a refrigerator), an ice maker and/or dispenser, a foodstuff dispenser (a liquid or powder flavoring dispenser) or any other combination of such.

Moreover, blending of foodstuff or ingredients may result in a blended product. Such blended products may include drinks, frozen drinks, smoothies, shakes, soups, purees, sorbets, butter (nut), dips or the like. It is noted that various other blended products may result from blending ingredients. Accordingly, terms such as “blended product” or “drink” may be used interchangeably unless context suggests otherwise or warrants a particular distinction among such terms. Moreover, such terms are not intended to limit possible blended products and should be viewed as examples of possible blended products.

According to one or more embodiments, a blender system may comprise a blender base having a pedestal engagable with a mixing assembly (e.g., blade). The blender base may comprise a housing that houses a motor. The motor may be operatively coupled to a power source. In another aspect, the blade base may include a control panel. The control panel may include user input/output (“i/o”) devices or interfaces that allow a user to control operation of the motor. For example, the control panel may include buttons, switches, knobs, dials, indicator lights (e.g., LEDs, etc.), screens (e.g., touch screens, LCD screens), or the like. The i/o devices may be operatively engaged with the control panel. The control panel may include circuitry, such as a printed circuit board (“PCB”), configured to receive input from the i/o device and control operation of the motor. In an aspect, the circuitry may be coupled to the motor.

In at least one embodiment, the control panel may comprise a control panel assembly (e.g., a faceplate). The control panel assembly may comprise a body that may operatively engage with i/o devices, such as snap-in switches and a speed control dial. A PCB may be mounted on the body and may include electronic components (e.g., circuitry) that may interact with the i/o devices. For instance, the PCB may include pressure sensitive switches, such as tach switches, that may be actuated by depressing a paddle or other i/o device. In an aspect, disclosed embodiments may allow for an integrated control panel. The integrated control panel may be separately constructed from a blender base and may be attached thereto at a later time. In another aspect, i/o devices and other components may be integrated into the control panel. The integration may provide for a more efficient control panel. For instance, the control panel may be efficiently assembled with a blender base, may reduce cost, may be interchangeable with other control panels, or the like. In an example, a user may customize the control panel by selecting types of controls, colors of controls and/or the control panel, or the like. In another aspect, a cost associated with producing a control panel may be reduced. For example, the number of components required to produce the control panel may be reduced. The control panel may be integrally or monolithically formed. This allows the control components and the input components (e.g., paddles, switches, knobs, etc.) to be directly and operatively coupled with the control panel without the requirement for additional fastening devices.

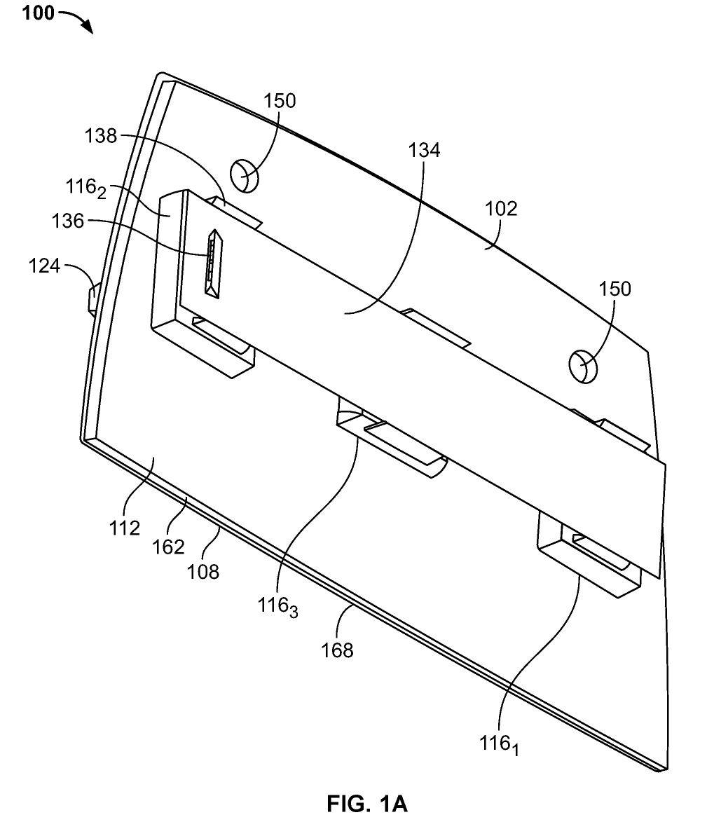

With reference now to the drawings, FIGS. 1A-3C are a control panel assembly 100. The control panel assembly 100 may comprise a body 102. The body 102 may comprise a first side 108 (e.g., front or face) and a second side 112 (e.g., back). The body 102 may comprise one or more mounting members 116₁₋₃ configured to operatively engage with control components, such as an i/o device (e.g., paddle 124) and/or circuitry (e.g., PCB 134). For instance, the mounting members 116₁₋₃ may comprise brackets, pins, threaded members (e.g., male or female), magnetic members, tabs, latches, clips, or the like. As illustrated, mounting members 116₁₋₂ may be configured for receiving and/or mounting switches or paddles 124 and 126. Mounting member 116₃ may be configured for receiving and/or mounting a control knob 130, which may control a speed of a motor, for example. While embodiments may be described as having two paddles 124 and 126, and a control knob 130, it is noted that control panel assembly 100 may comprise a different number of i/o devices and/or different types of i/o devices (e.g., touch screens, etc.). In an example, the control panel assembly 100 may comprise n mounting members (e.g., 116₁₋ₙ), where n is a whole number. The control panel assembly 100 may also comprise m i/o devices (e.g., paddles, knobs, etc.) where m is a number.

The first side 108 may be exposed or visible to a user when assembled with a blender base 200, as depicted in FIG. 5. In an aspect, the i/o device (e.g., paddles 124 and 126, and control knob 130) may extend from the first side 108 or may be otherwise accessible to a user. Circuitry, such as PCB 134, may be coupled to the second side 112, such as via one or more of the mounting members 116₁₋₃. For instance, the PCB 134 may be held by one or more clips 138. According to an embodiment, the paddles 124 and 126, and control knob 130 may interact with circuitry of the PCB 134, such as tach switches 160 and 162, or the like. In an example, paddles 124 and 126 may respectively interact with a first tach switch 160 (as shown in FIG. 1A) and a second tach switch 162 (as shown in FIG. 1A). For instance, a user may utilize first paddle 124 to start or stop a motor of a blender. In a first position (e.g., flipped up/down) the first paddle 124 may actuate the first tach switch 160, such as via a paddle arm or actuator 128. This actuation may facilitate transmission of an instruction to a motor. In a second position, the first paddle 124 may de-activate or otherwise alter a state of the first tach switch 160. For example, when the first paddle 124 is in the second position, the first tach switch 160 may instruct the motor to stop or not drive a blade assembly. It is noted that the instruction may include a signal to stop the motor and/or may include a lack of a signal. In another example, actuation of the first tach switch 160 may initiate a blending process, such as a timed blending process which may terminate after a certain time without regard to a position of the first paddle 124.

According to another aspect, the second paddle 126 may similarly interact with the second tach switch 162 to “pulse” the motor. For example, if a user holds the second paddle 126 in a first position, the second paddle 126 will activate the second tach 162 switch, which will instruct the motor to activate. In an aspect, the second paddle 126 may be biased in a second (e.g., an off) position such that it will revert to the off position when not pressed or otherwise manipulated by a user. In the off position, the tach switch may instruct the motor to not activate or otherwise stop. It is noted that instructing the motor to stop may include a signal and/or a lack of a signal. It is further noted that the first paddle 124 and/or the second paddle 126 may be biased to the off position by various desired mechanisms, such as springs, magnets, mechanical biasing, or the like. In another aspect, the position of the control knob 130 may be associated with a particular blending pattern. The blending patterns may be associated with making a particular product, such as, for example, hot soups, cold soups, frozen drinks, or the like.

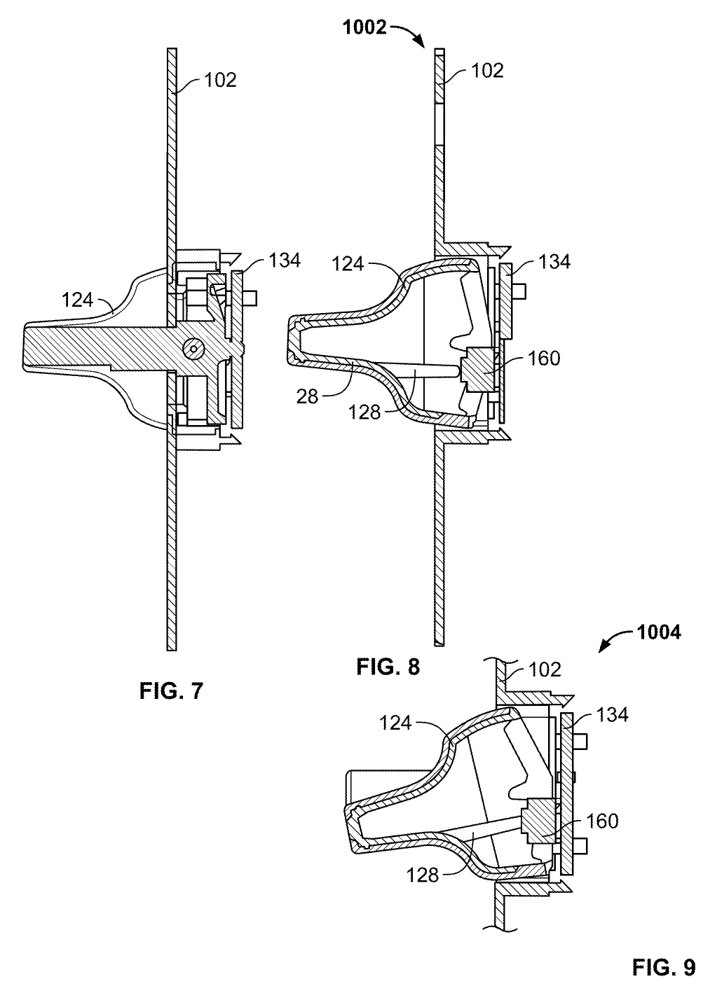

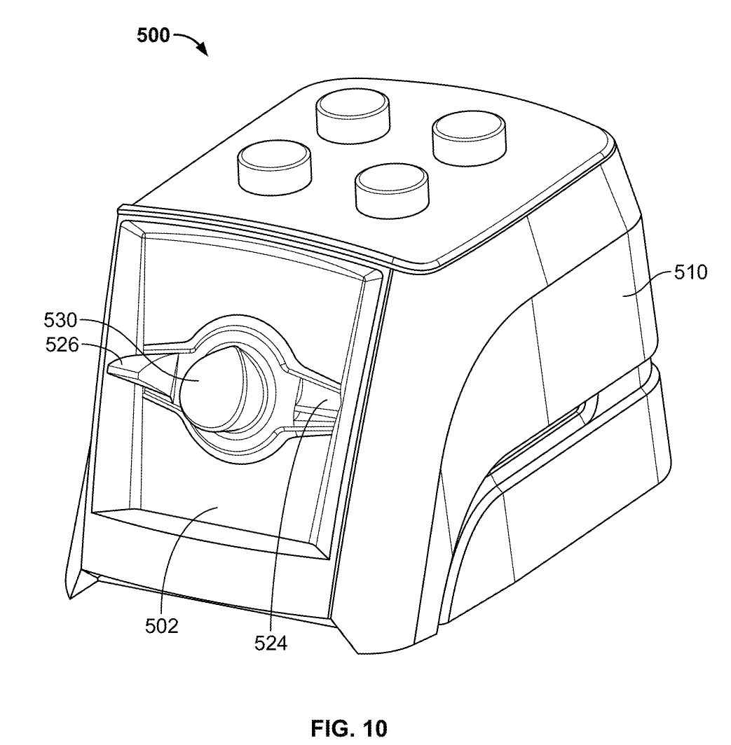

As shown in FIGS. 7-9, the paddle 124 may actuate tach sensor 160 by moving from a first position 1002 to a second position 1004 shown in FIG. 12. FIG. 7 is a partial cross-sectional view through body 102. FIG. 8 is a partial cross-sectional view through body 102 and paddle 124. Actuator 128 may extend from a body 28 of paddle 124. When a user manipulates the paddle 124 (e.g., flips-up, flips-down, etc.) from first position 1002 to second position 1004, the actuator 128 may actuate tach switch 160.

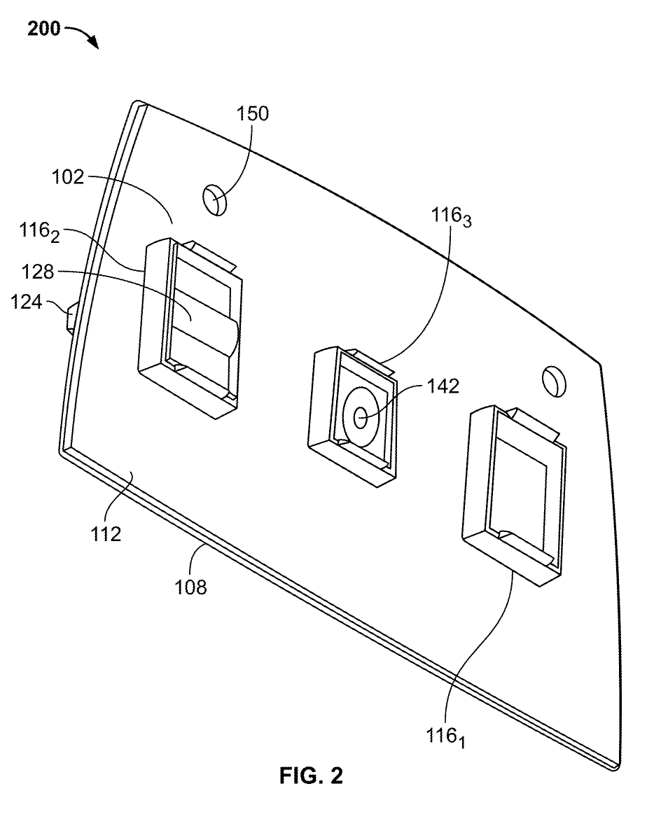

Control knob 130 may be operatively engaged with a dial member 140. The dial member 140 may be configured to control a blending process of a blender. For instance, the dial member 140 may be coupled to the PCB 134 to generate instructions to control a speed, temperature, torque, speed at which the blades rotate, or other parameter of a motor and/or blending process. In an example, a user may rotate the control knob 130 to a desired position. Each position may be associated with a particular speed of the motor and/or blades. The speed may be represented by indicia disposed on the first side 108 of the body 102, the control knob 130, and/or other components. A dial interface 142, as shown in FIG. 2, may operatively engage and/or interact with the PCB 134 to generate the instructions.

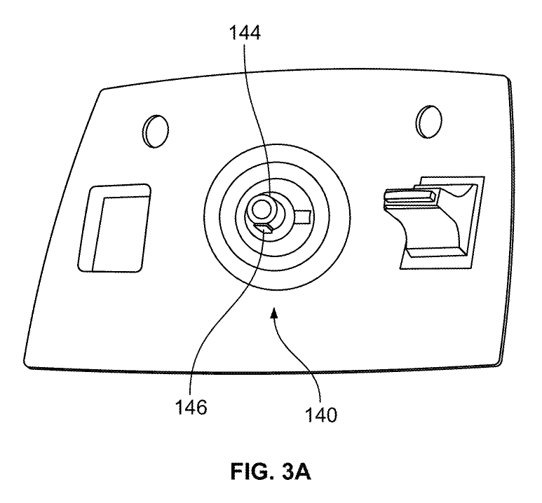

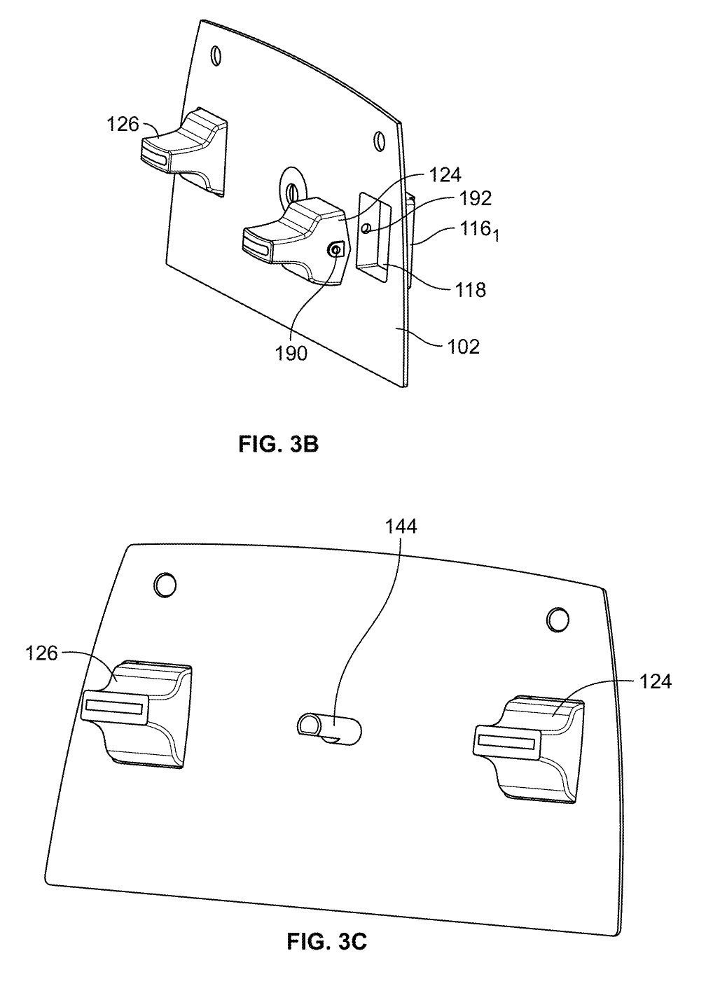

In embodiments, various components of the control panel assembly 100 may be assembled or coupled together to provide an integrated control panel assembly 100. The integrated control panel assembly 100 may allow the control panel assembly 100 to be completely (or partially) assembled prior to attaching the control panel assembly 100 to the blender base 200. For instance, paddle 124 may be inserted into or otherwise mounted via the mounting member 116₁. The paddle 124 may be pushed or snapped into place. This may generate an audio, tactile, and/or visual signal that may be observable by a user. Likewise, paddle 126 may be inserted into or otherwise mounted via the mounting member 116₂. While described as mechanically “snapping” into a position, it is noted that the paddles 124 and 126 may be coupled to the control panel assembly 100 via other means, such as via couplers and/or fasteners, including clips, tabs, threaded members (e.g., bolts, screws, etc.), channels, cleats, magnets, friction fit, mechanical nesting, or the like. As shown in FIGS. 3B and 3C, paddle 124 may be inserted into an opening 118 of the body 102. One or more protrusions 190 of the paddle 124 may be operatively coupled with one or more aperture 192 of the mounting member 116₁. In an aspect, the one or more protrusions 190 and one or more aperture 192 may act as an axle and hub to allow for movement of the paddle 124.

In another aspect, the control knob 130 may be attached or otherwise coupled to the dial member 140, as shown in FIGS. 3A and 3C. For instance, dial member 140 may include a protrusion or peg 144 and/or an alignment member 146. The control knob 130 may include an aperture or tubular opening comprising a similar shape as the peg 144 and alignment member 146. In this manner, the control knob 130 may be correctly positioned on the control panel assembly 100. It is noted that the control knob 130 may be operatively attached to the dial member 140 via mechanical nesting (e.g., friction fit), threaded members (e.g., female and/or male), magnets, hooks, clips, or the like.

It is further noted that, while embodiments are described as comprising disparately formed components, the various components may be monolithically formed. For instance, paddle 124, paddle 126, control knob 130, PCB 134, and body 102 are described as being generally modular, such that the various components may be attachable (e.g., removably or irremovably), replaceable, and/or interchangeable. In other embodiments, two or more of the paddle 124, paddle 126, control knob 130, PCB 134, or body 102 may be monolithically formed and/or irremovably attached. For instance, PCB 134 may be monolithically formed with body 102.

In embodiments, the control panel assembly 100 may operatively attach to the blender base 200 at an appropriate position. One or more apertures 150 may be configured to receive an attachment member, such as a pin, bolt, rivet, screw, or the like. It is noted that the one or more apertures 150 may be threaded (e.g., male or female) or the like. The attachment member may, for example, be inserted through the one or more apertures 150 and may engage with the blender base 200. It is noted that the control panel assembly 100 may comprise different apertures, a different number of apertures, no apertures, or may comprise other coupler and/or fastener mechanisms.

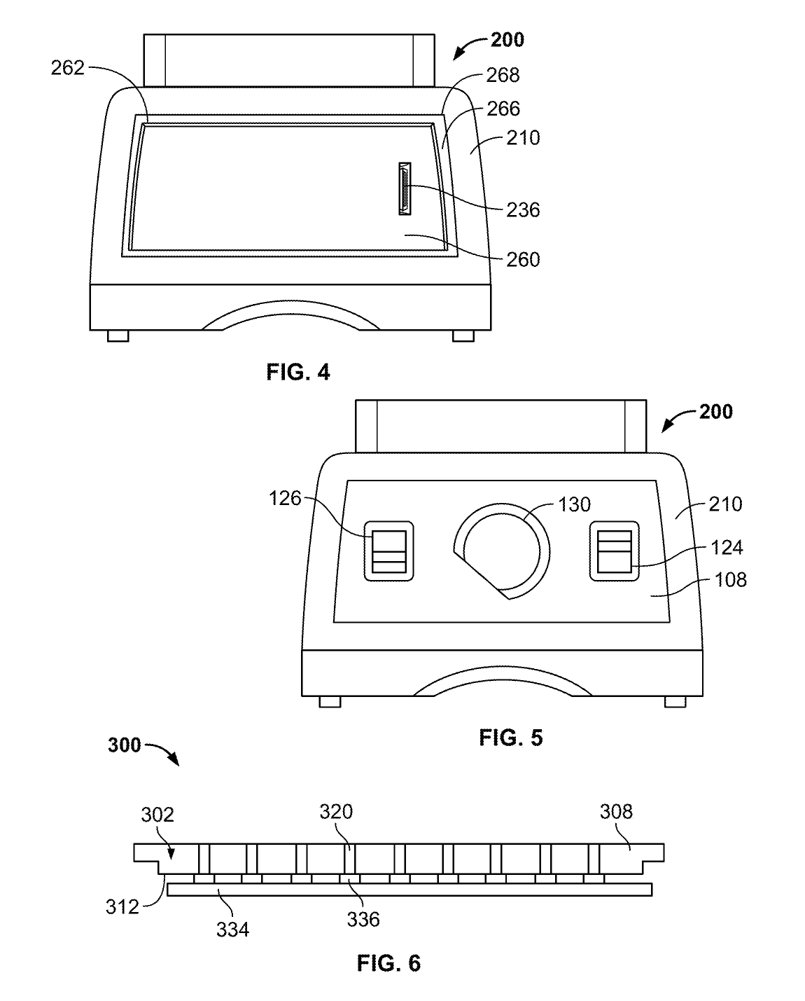

The PCB 134 may comprise one or more connection port 136. The connection port 136 may comprise any appropriate type of connector and/or port. In another aspect, the connection port 136 may comprise a male or female port. In an example, the connector port 136 may comprise pins that operatively couple to pins of a connection port 236 of the blender base 200, as shown in FIG. 4. It is noted that the connection port 136 and the connection port 236 of the blender base 200 may comprise opposed male/female ports. According to an aspect, the connection port 136 may be positioned to operatively couple to the connection port 236 of the blender base 200 when the control panel assembly 100 is properly positioned with and/or attached to the blender base 200. It is noted that various types of connection ports 136 and 236 may be utilized. For instance, the connection ports 136 and 236 may comprise universal serial ports (USB ports), serial ports, parallel ports, specialized ports, or the like. It is further noted that the blender base 200 and the control panel assembly 100 may comprise wireless connections, such as near field communications (NFC), or the like.

In at least one embodiment, the second side 112 may generally protrude from the first side 108. In an aspect, the second side 112 may comprise a perimeter 162 that is generally smaller than a perimeter 168 of the first side 108. The perimeter 162 of the second side 112 may be configured to be inserted and/or received by an aperture 260 of the blender base 200. The perimeter 162 may be configured to be generally smaller than or about equal to a perimeter 262 of the aperture, such that the perimeter 162 may mechanically nest (e.g., friction fit) within the aperture 262 of the blender base 200. For instance, the control panel assembly 100 may snap or click into place. In another aspect, the perimeter 168 of the first side 108 may be generally larger than the perimeter 262 of the aperture 260, such that the perimeter 168 may be prevented from being inserted in the aperture 260. According to at least one embodiment, the first side 108 may be generally flush with a side 210 of the blender base 200. In an example, the first side 108 may rest and/or be at least partially adjacent to a lip 266 having an outer perimeter 268. The outer perimeter 268 may comprise a similar shape and/or generally similar dimension as the perimeter 168 of the first side 108. For instance, the first side 108 may mechanically nest within the perimeter 268. In at least one other embodiment, the first side 168 may be recessed and/or protrude from the side 210.

It is noted that control panel assembly 100 may be operatively connected (e.g., removably or irremovably) to the blender base 200 via various other means. For instance, the control panel assembly 100 may be connected to the blender base 200 via mechanical couplers (e.g., hooks, clips, etc.), magnets, chemical compositions (e.g., epoxies, adhesives etc.), or the like. It is further noted that the blender base 200 may comprise other or different components. In one example, a side wall of a blending container may comprise a face plate that may generally cover the first side 108 of the control panel assembly 100, except for the i/o devices. In another example, one or more gaskets may be positioned between and/or attached to (e.g., removably or irremovably) the blender base 200 and the control panel assembly 100. The one or more gaskets may prevent foodstuff or any other liquid from interacting with the connection port 136 and/or 236, or other components. In another aspect, the one or more gaskets may absorb vibrations and/or reduce noise generated by the blender base.

In another aspect, while shown as generally flat in FIGS. 1-7, the body 102 may comprise various shapes and dimensions. For instance, the body 102 may be generally polygonal, elliptical, and/or irregular in shape. In another aspect, the body 102 may comprise bends or curves, such that the body 102 may be exposed on a plurality of sides of the blender base 200.

According to embodiments, an integrated control panel may comprise other i/o devices than shown in FIGS. 1A-3C. For example, with reference to FIG. 6, depicted is an integrated control panel 300 for a blender assembly according to various disclosed aspects. The control panel 300 may comprise a body 302 having a first side 308 and a second side 312. It is noted that the first side 308 and the second side 312 may be monolithically formed, operatively attached, or the like. The body 302 may comprise one or more mounts (not shown) which may be configured to mount or support PCB 334. The PCB 334 may comprise and/or be coupled to one or more actuators, such as one or more tach switches 336. The tach switches 336 may be configured to interact with one or more mechanical actuators 320. The mechanical actuators 320 may comprise i/o devices that may be at least partially exposed to a user. For instance, the i/o devices may comprise buttons, toggle switches, paddles, knobs, pressure sensitive switches, or the like. In at least one embodiment, the mechanical actuators 320 may be disposed underneath a surface and/or may replicate a touch screen or touch panel. This may allow a user to feel mechanical actuation of the mechanical actuators 320 and may allow the external surface to be generally, physically separated from the PCB 334.

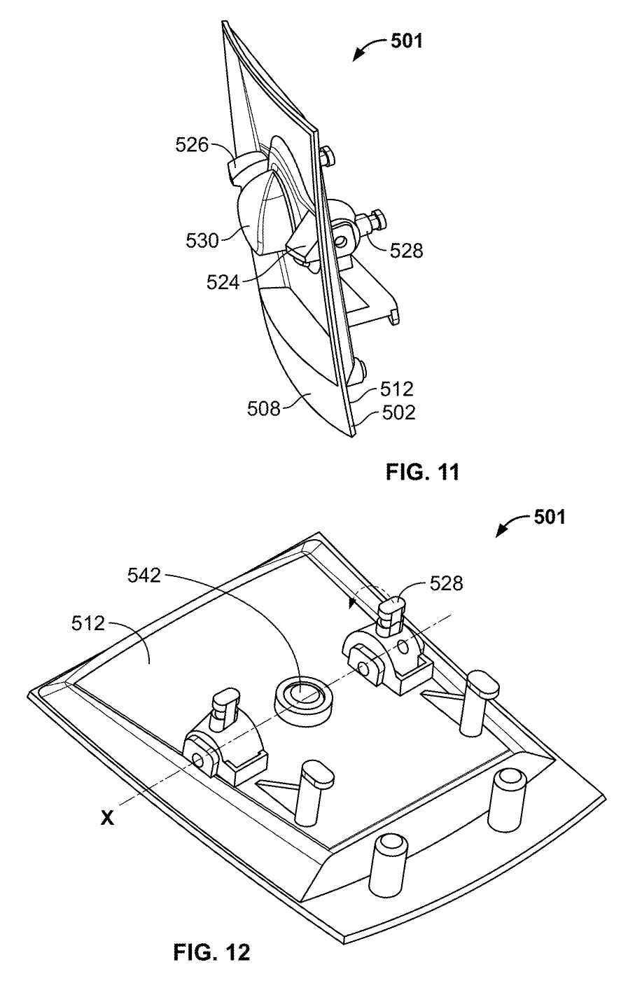

Turning now to FIGS. 10-18, there is a blending system 500 that may include a blender base 510. The blender base 510 may operatively engage with and/or include a control panel 501. The control panel 501 may include a body 502 supporting user interfaces or controls. In an example, the user interfaces may include paddle 524, paddle 526, and knob 530. It is noted that blending system 500 may include aspects described with reference to FIGS. 1A-9. For instance, paddle 524 may include similar aspects as paddle 124.

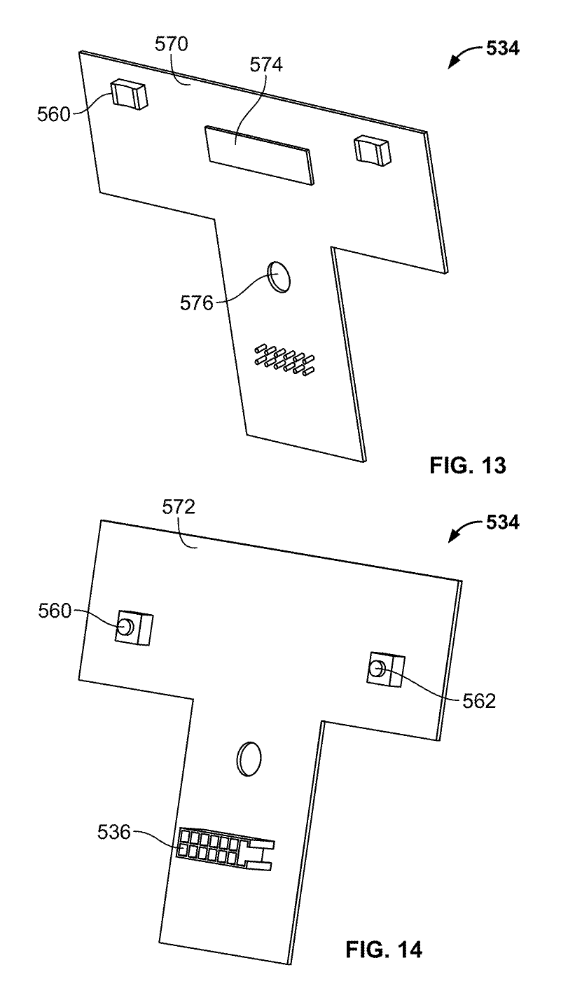

Body 502 may include a first side 508 and a second side 512. First side 508 may be generally exposed to an outer environment. In an aspect, first side 508 may be configured to receive and/or allow access to paddle 524, paddle 526, and knob 530. A PCB 534, as shown in FIGS. 13-14, may be operatively attached to the second side 512. The PCB 534 may be shaped and configured receive input from input devices of the blending system 500. For instance, PCB 534 may be generally T-shaped or any other appropriate shape. The PCB 534 may include one or more tach sensors (e.g., first tach sensor 560 and second tach sensor 562). Furthermore, the PCB 534 may include one or more communication ports 536 that may operatively couple to a communication port of blender base 510.

In at least one embodiment, a second side 570 of the PCB 534 may face second side 512 when PCB 534 is attached to control panel 501. A first side 572 may be opposite the second side 570. The second side may include one or more supports, such as support 574. In another aspect, an aperture 576 may be formed through the PCB 534 to allow for interfacing with knob 530 and/or other input devices. A user may actuate or otherwise manipulate paddle 524, paddle 526, or knob 530 to control a motor housed within the blender base 510. When a user manipulates one or more of the controls, operative ends of the controls may interact with a PCB 534. For instance, when a user presses paddle 526, a paddle actuator 528, may move to press tach sensor 562. According to an example, the paddles 524/526 may be rotated about an axis X to move actuators (e.g., actuator 528) towards body 502.

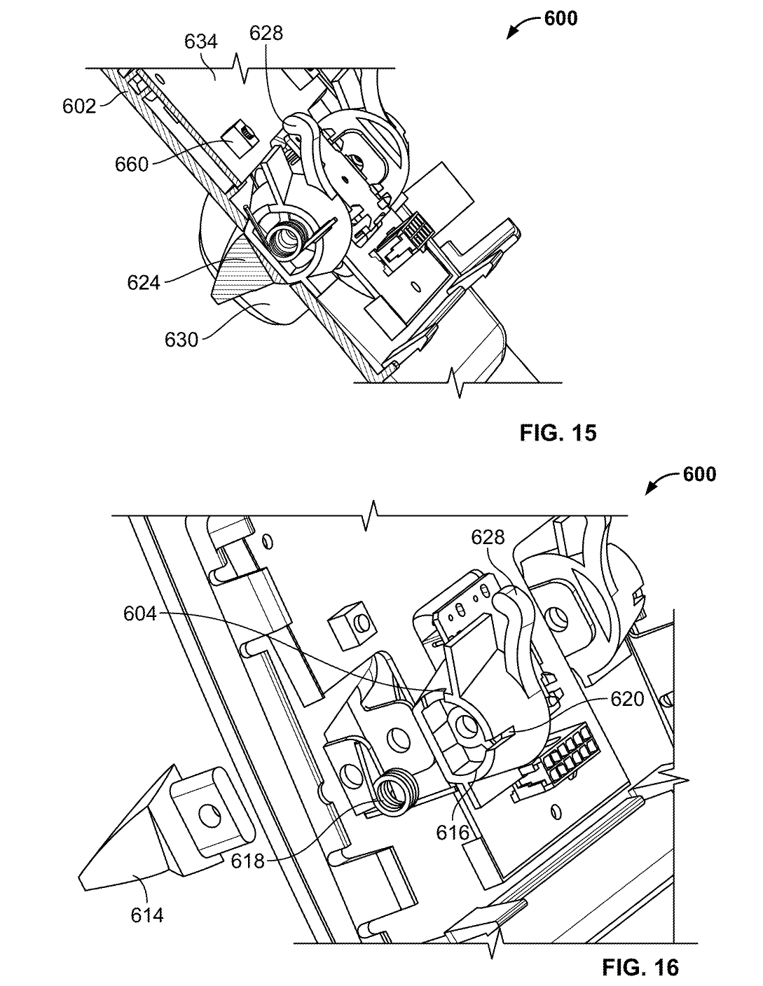

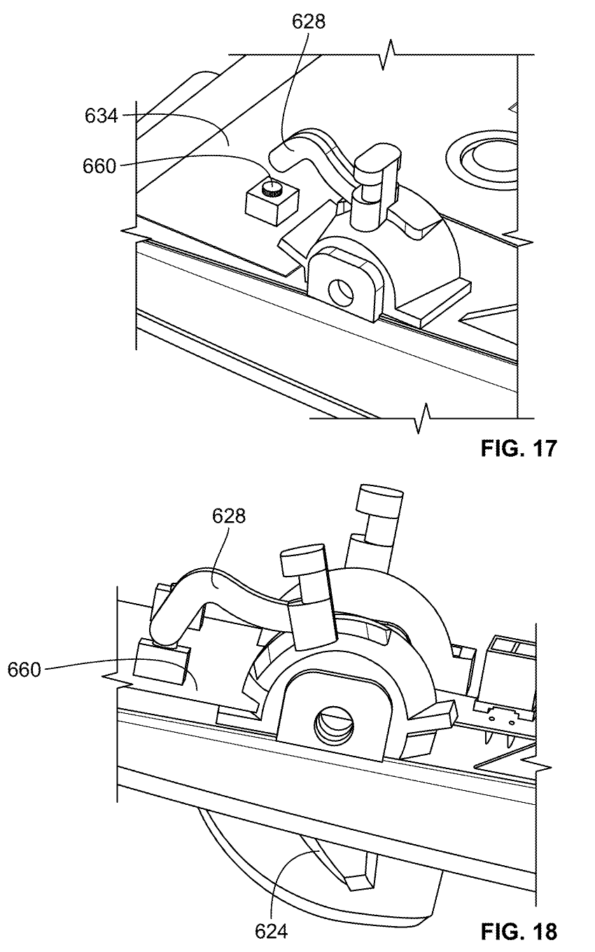

FIGS. 15-16 and 17-18 illustrate another embodiment of a control panel 600 that may be operatively attached to blender base 510. Control panel 600 may comprise one or more controls, such as paddle 624 and knob 630. As shown in the partial cross-sectional view of FIG. 18 and FIGS. 17-18, a PCB 634 may be attached to a body 602. Paddle 624 may be manipulated such that a hammer or actuator 628 is may contact a tach sensor 660. For instance, actuator 628 may be in a first position as shown in FIG. 17. A user may press the paddle 624 to cause actuator 628 to travel to a second position shown in FIG. 18. In the second position, the actuator 628 may depress or actuate the tach sensor 660.

The paddle 624 may be of a single construction or may comprise one or more members that may be attached (e.g., removably or irremovably) together. For instance, the paddle 624 may comprise a lever member 614 configured to provide an interface to a user. The lever member 614 may be attached to an internal member 616 (which may comprise actuator protruding therefrom) and/or a biasing member 618, such as a coiled spring. Internal member 616 may comprise an inlet 620 that may receive a portion of the biasing member 618. In operation, the biasing member 618 may be compressed/depressed to allow a user to move the paddle 624. A stop 604 of the internal member 616 may provide a hard or physical stop that may prevent a user from forcing the actuator 628 and/or biasing member 618 past a preferred position, such that tach sensor 660, PCB 634, and/or paddle 624 are not damaged. When a user releases paddle 624, the biasing member 618 may force the internal member 616 to return to a resting position (e.g., as shown in FIG. 17).

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof.

What is claimed is:

1. A control panel for a blender assembly, the control panel comprising:
a body comprising a first side and a second side;
at least one input/output device operatively disposed at the first side; and
at least one connection port operatively disposed at the second side, wherein the connection comport operatively couples to a blender base of the blender assembly.

2. The control panel of claim 1, further comprising:
a printed circuit board coupled to the body at the second side.

3. The control panel of claim 2, wherein the printed circuit board is in operative communication with the at least one input/output device.

4. The control panel of claim 2, wherein the printed circuit board is operatively coupled to the at least one connection port.

5. The control panel of claim 2, wherein the printed circuit board is in operative communication with the at least one input/output device.

6. The control panel of claim 2, further comprising at least one tack switch extending from the printed circuit board.

7. The control panel of claim 1, wherein the at least one input/output device comprises at least one switch.

8. The control panel of claim 1, wherein the at least one input/output device comprises at least one knob.

9. The control panel of claim 1, wherein the at least one input/output device comprises at least one touch sensor.

10. A control panel for a blender assembly comprising a motor, the control panel comprising:
a body comprising a first side and a second side, wherein the first side is exposed when the body is operatively attached to the blender assembly;
at least one input/output device disposed on the first side; and
a printed circuit board disposed on the second side and in communication with the at least one input/output device,
wherein the at least one input/output device controls operation of the motor.

11. The control panel of claim 10, wherein the printed circuit board comprises a first connection port operatively electrically connecting the printed circuit board to the motor.

12. The control panel of claim 11, wherein the printed circuit board comprises a second connection port operatively electrically connecting the printed circuit board to the at least one input/output device.

13. The control panel of claim 10, wherein the at least one input/output device comprises a touch screen.

14. The control panel of claim 10, wherein the at least one input/output device comprises an interchangeable input/output device.

15. A blender comprising:
a motor operatively coupled to a mixing member;
a housing operatively enclosing at least a portion of the motor;
a control panel operatively coupled to the housing, wherein the control panel comprises:
at least one input/output device; and
a printed circuit board in operative communication with the at least one input/output device, the printed circuit board comprising an electrical connector that operatively connects the printed circuit board to the motor.

16. The blender of claim 15, wherein the at least one input/output device controls operation of the motor.

17. The blender of claim 16, wherein the at least one input/output device controls a speed of motor.

18. The blender of claim 16, wherein the at least one input/output device controls a mode of the motor.

19. The control panel of claim 16, further comprising at least one gasket operatively disposed between the control panel and the blender housing.

20. The control panel of claim 19, wherein the gasket comprises an elastomeric material.
